(19) United States
(12) Patent Application Publication
(10) Pub. No.: US 2011/0156927 A1
(43) Pub. Date: Jun. 30, 2011

(54) VEHICULAR TRAFFIC CONTROL SYSTEM

(76) Inventor: Gerald ULMER, Conestoga, PA (US)

(21) Appl. No.: 12/649,767

(22) Filed: Dec. 30, 2009

(51) Int. Cl. G08G 1/095

(52) U.S. Cl. 340/907

(57) ABSTRACT

A traffic control system and a traffic signal to increase traffic signal visibility. The traffic control system has a traffic signal with a first face and an oppositely facing second face. The first face has a first red light, a first amber light and a first green light. The first face is directed to and controls vehicles travelling in a first direction in a first lane of traffic. The second face has a second red light, a second amber light and a second green light. The second face is directed to and controls vehicles in a second direction in a second lane of traffic, the second direction is opposed to the first direction. The traffic signal is positioned over the first lane of traffic, whereby vehicles travelling in the second lane of traffic have an unobstructed view of the second face of the at least one first traffic signal.

### FIELD OF THE INVENTION

The invention relates generally to a vehicular traffic control system and, more particularly, to a traffic control system in which the traffic signal is not obstructed from the vision of oncoming drivers.

### BACKGROUND OF THE INVENTION

Traffic lights are positioned at road intersections, pedestrian crossings, and other locations to control competing flows of traffic. They are used at busy intersections to more evenly apportion delay to the various users and to assign the right of way to road users by the use of lights in standard colors (Red-Amber-Green). Traffic control systems and traffic light technology are constantly evolving with the aims of improving reliability, visibility, and efficiency of traffic flow.

There are significant differences from place to place in how traffic lights are mounted or positioned so that they are visible to drivers. Depending upon the location, traffic lights may be mounted on poles situated on street corners, hung from horizontal poles or wires strung over the roadway, or installed within large horizontal gantries that extend out from the corner and over the right-of-way. Places such as California are particularly rigorous in ensuring that drivers can see the current state of a traffic light. One entrance to a typical large intersection, with three through lanes, two dedicated left-turn lanes, and a crosswalk, may have as many as three traffic lights for the left-turn lanes, three for the through lanes, and a pedestrian signal for the crosswalk. Those numbers must be multiplied by four to cover all four ways to enter a typical intersection.

In addition to being positioned and mounted for desired visibility for their respective traffic, some traffic lights are also aimed, louvered, or shaded to minimize misinterpretation from other lanes. For example, a Fresnel lens on an adjacent through-lane signal may be aimed to prevent left-turning traffic from anticipating its own green arrow. One example of the Fresnel lens application common in the USA is the 3M Model 131 traffic signal (dubbed the “Programmed Visibility” signal). Although 3M has recently discontinued the M-131, it became a popular traffic signal for skewed or complex intersections.

Traffic signals, in some areas, are located at the stop line on the same side of the intersection as the approaching traffic and are often mounted overhead as well as on side of the road. In other areas, there is a pole-mounted signal on the same side of the intersection, but additional pole-mounted and overhead signals are usually mounted on the far side of the intersection for better visibility. In still other areas, signals facing all four directions are hung directly over the intersection on a wire strung diagonally over the intersection.

While traffic control systems and traffic lights operate satisfactorily, they are not without shortcomings. Certain problems confront a motorist when approaching a blind intersection or when approaching an intersection in which motorist vision is obstructed in a direction toward the traffic signal by a large tractor trailer truck or the like.

It would therefore be beneficial to provide a traffic control system and a traffic signal which could provide additional warning to the motorist by providing additional functionality to signals to allow the motorist to view the appropriate signal without obstruction and in all weather conditions. It would also be beneficial to provide such additional safety benefits without significantly increasing the cost to municipalities associated with the installation of additional traffic signals.

### SUMMARY OF THE INVENTION

One aspect of the invention is directed to a traffic signal for controlling traffic in a first lane of traffic and a second lane of traffic which is opposed to the first lane of traffic. The traffic signal has a first face and a second face. The first face has a first red light, a first amber light and a first green light which are directed to and control traffic travelling in a first direction in the first lane of traffic. The second face has a second red light, a second amber light and a second green light which are directed to and control traffic in a second direction in the second lane of traffic. The second direction is opposed to the first direction. The traffic signal is positioned proximate the first lane of traffic, whereby traffic travelling in the second lane of traffic has an unobstructed view of the second face of the traffic signal.

The first red light, the first amber light and the first green light of the traffic signal may have different shapes than the second red light, the second amber light and the second green light. The switching between the first red light, the first amber light and the first green light on the first face is sequenced with the switching between the second red light, the second amber light and the second green light on the second face.

Another aspect of the invention is directed to a traffic control system for controlling vehicles at an intersection. The traffic control system has one or more first traffic signals positioned over a first lane of traffic in which vehicles move in a first direction. Additionally, one or more second traffic signals are positioned over a second lane of traffic in which vehicles move in a second direction. At least one of the first traffic signals has a first face and a second face. The first face has a first red light, a first amber light and a first green light, which are directed to and control vehicles travelling in the first direction in the first lane of traffic. The second face has a second red light, a second amber light and a second green light, which are directed to and control vehicles in the second direction in the second lane of traffic. The second direction is opposed to the first direction. The at least one first traffic signal is positioned proximate the first lane of traffic, whereby vehicles travelling in the second lane of traffic have an unobstructed view of the second face of the at least one first traffic signal.

Another aspect of the invention is directed to a traffic control system to increase traffic signal visibility. The traffic control system has a traffic signal with a first face and an oppositely facing second face. The first face has a first red light, a first amber light and a first green light. The first face is directed to and controls vehicles travelling in a first direction in a first lane of traffic. The second face has a second red light, a second amber light and a second green light. The second face is directed to and controls vehicles in a second direction in a second lane of traffic; the second direction is opposed to the first direction. The traffic signal is positioned over the first lane of traffic, whereby vehicles travelling in the second lane of traffic have an unobstructed view of the second face of the at least one first traffic signal.

The use of the traffic control system and traffic signals as described herein has several advantages. The traffic control system and traffic signals provide additional warning to the motorist by providing additional functionality to the signals, allowing the motorist to view the appropriate signal without obstruction. The traffic control system and traffic signals provide the additional safety benefits without significantly increasing the cost to municipalities associated with the installation of additional traffic signals.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a side view of a traffic signal as described here.

FIG. 2 is a back perspective of the traffic signal showing the additional lights provided thereon.

FIG. 3 is a top plan view showing a traffic control system and traffic signal as described herein.

FIG. 4 is a perspective view of the intersection of FIG. 3 showing the obstruction realized by a motorist when positioned behind a large vehicle.

FIG. 5 is a back perspective view of the traffic signal showing various configurations of the additional lights provided thereon.

### DETAILED DESCRIPTION OF THE INVENTION

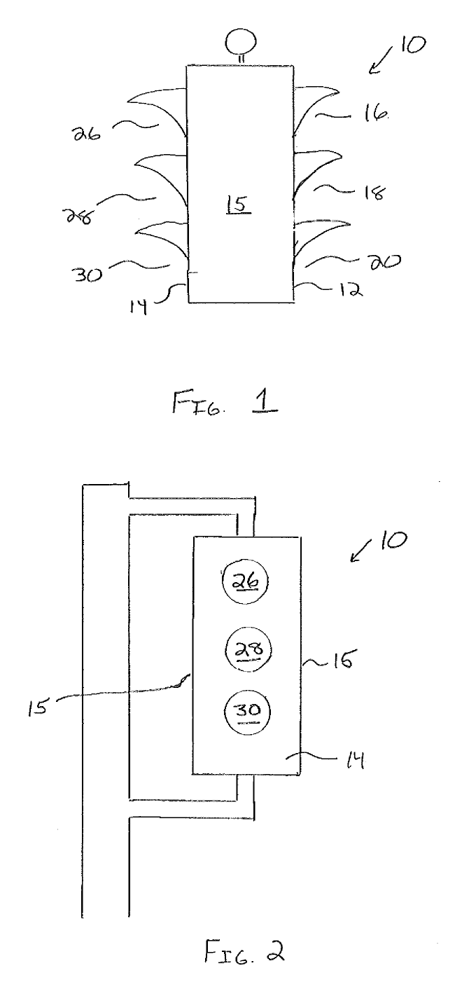

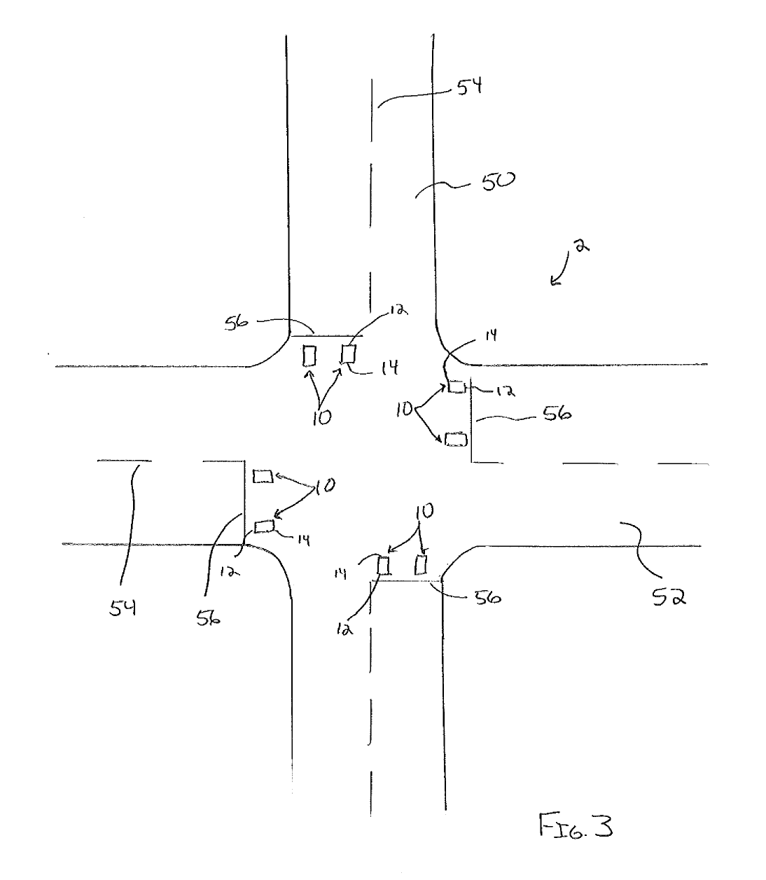

Referring to FIGS. 1 and 2, a traffic signal 10, according to the present invention, has a front or first face 12, an oppositely facing rear or second face 14, and side faces 15 which extend between the front face 12 and rear face 14. The front face 12 of the traffic signal 10 is positioned to face and control vehicular traffic in a first direction, which is generally referred to as the oncoming or opposing vehicular traffic for that respective traffic signal. As is generally known in the art, a red “STOP” signal 16 is located above a green “GO” signal 20 with a yellow or amber “WARNING” signal 18 located between the two. The significance or meaning of these signals are well known and will not be described here other than to state that yellow signal 18 will be illuminated when green signal 20 is turned off to indicate to an oncoming motorist that red signal 16 will soon be switched on. When red signal 16 is switched on, yellow signal 18 is switched off. Generally, the yellow signal 18 is not actuated when the signal sequence is from the red signal 16 to the green signal 20. Sequencing and timing of signal operations may be controlled in a well-known manner from a control unit (not shown) located near the intersection when the intersection controlled is relatively isolated or, in an urban situation having a series of traffic-signal-controlled intersections, the control unit may be a centralized computer system that also synchronizes the operation of a series of traffic signals to maintain a steady traffic flow at the prescribed speed limit.

The rear face 14 of the traffic signal 10 is positioned to face and control vehicular traffic in a second direction which is opposed to the first direction. For the respective traffic signal 10, the vehicular traffic in the second direction is generally referred to as the opposing vehicular traffic. The operation of the rear face 14 is synchronized with the operation of other respective traffic signals which have their front faces positioned to control traffic in the second direction. The operation of the lights associated with the second face 14 is similar to the operation of the front face 12. A red “STOP” signal 26 is located above a green “GO” signal 30 with a yellow or amber “WARNING” signal 28 located between the two. The significance or meaning of these signals are similar to traditional front face lights and will not be described here other than to state that yellow signal 28 will be illuminated when green signal 30 is turned off to indicate to an oncoming motorist that red signal 26 will soon be switched on. When red signal 26 is switched on, yellow signal 28 is switched off. Generally, the yellow signal 28 is not actuated when the signal sequence is from the red signal 26 to the green signal 30. Sequencing and timing of signal operations may be controlled as recited above.

Referring to FIG. 5, the lights 26′, 28′, 30′ associated with the rear face 14 may have different configurations, rather than just the circular configurations associated with the lights of the front face 12. While square configurations are shown, other configurations, such as triangular, elliptical, rectangular, X-shaped, etc. may be used. The use of different configurations on the rear face 14 allows the motorist to understand that the signals emanating from the rear face 14 are not the primary signal for that motorist, as will be more fully described below.

In all of the embodiments of the traffic signal 10, the lights on the front face 12 and rear face 14 may be illuminated by light-emitting diodes (LEDs), incandescent, halogen light bulbs or other known light sources. Control circuits and wiring (not shown) are provided in each traffic signal 10 to insure that the sequencing of lights on the front face 12 and lights on the rear face 14 are properly coordinated. An example of the coordination between the front face 12 and rear face 14 is as follows: as the green signal 20 on the front face 12 is activated, the red signal 26 on the rear face 14 is activated; as the yellow signal 18 on the front face 12 is activated, the red signal 26 on the rear face 14 remains activated; and as the red signal 16 on the front face 12 is activated, the green signal 30 on the rear face 14 is activated, until several seconds prior to the red signal 16 changing to the green signal 20, at which time the amber signal 28 of the rear face 14 is activated.

Referring to FIG. 3, a road or street 50 is intersected by a cross street 52, and vehicular traffic along both streets is controlled by traffic signals 10. Each street is shown as carrying two-way traffic, so a center line 54 is provided for separating or dividing the traffic flowing in opposite directions. A simple stop line 56 may be provided to indicate to motorists the stopping position for vehicles stopped by each traffic signal 10. While intersections may have additional features, such as cross walks to indicate the safe cross areas for pedestrians to cross the streets, such features are not relevant to the invention and will not be discussed in detail. While a four way intersection is shown in FIG. 2, the traffic signals 10 and control system 2 may be used at other types of intersections having traffic enter from two or more directions.

The traffic signals 10 are mounted at intersections in a similar manner to known traffic lights. Depending upon the location, traffic lights may be mounted on poles situated on street corners (as shown in FIG. 2), hung from horizontal poles or wires strung over the roadway (as shown in FIG. 1), or installed within large horizontal gantries that extend out from the corner and over the right-of-way. In some instances, traffic lights may be mounted with their faces arranged horizontally, often with supplemental vertical signals on the side, while others use vertical signals almost exclusively. Horizontal traffic lights have consistent orientation, like their vertical counterparts.

As is known in the art, traffic signals may be located at the stop line on same side of the intersection as the approaching traffic. Additional traffic signals may be mounted on the far side of the intersection for better visibility.

When mounting traffic signals 10, it is important that both the front face 12 and the rear face 14 be free of obstruction. As lights project from both the front face 12 and rear face 14, the traffic signals 10 must be mounted in a manner which allows motorists travelling in the first direction and motorists travelling in the second direction to have an unobstructed line of sight, free of any mounting posts or the like.

It is becoming more common for a motorist to approach an intersection and not have a clear view of the traffic signal provided over his/her lane. This can occur because of geography, i.e. sharp turn, or because of traffic congestion. Whether the traffic light is positioned at the stop line or at the far side of the intersection, if a large tractor trailer or other such object is positioned in front of the motorist, the motorist may be unable to view the traffic signal properly positioned in his/her lane. This can cause the motorist to follow the truck through the intersection after the light has turned red or cause the motorist to apply his/her brakes is a quick and unsafe manner. In either instance, the motorist may be placed in an unsafe position, and cause others to be placed in an unsafe position, merely because the motorist cannot adequately see the traffic signal at a safe distance and in a timely manner.

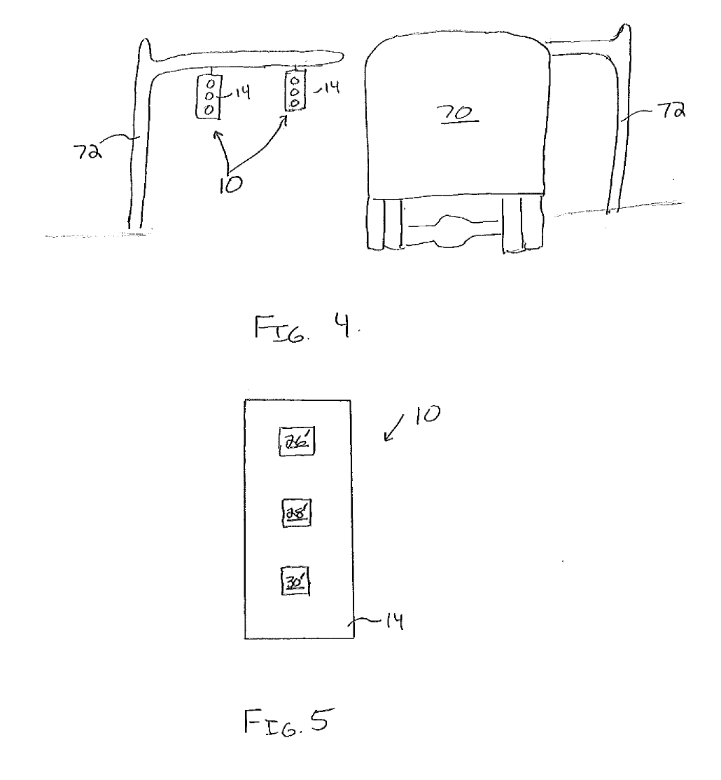

As shown in FIG. 4, according to the present invention, the traffic control system 2 and the traffic signals 10 allow the motorist a significantly improved line of sight of the traffic signals 10, even when the motorist is positioned behind a large vehicle or object 70. Traffic signals 10 are positioned on a large pole 72 extending over the oncoming lanes of traffic. The pole 72 may be positioned at the stop line of the intersection for the respective motorists or at the far side of the intersection at the stop line of the intersection for oncoming traffic. The positioning of traffic signals over the lanes of oncoming traffic provides a line of sight from the motorists to the traffic lights 10 which is not obstructed by large vehicles 70 which are travelling in the same direction as the motorist. Alternatively, the positioning of the traffic signals next to the lane of oncoming traffic on the shoulder of the road provides the same advantage.

The traffic control system 2 and traffic signals 10 also improve the visibility of the lights when the traffic signals 10 are positioned close to a sharp curve. Additionally, with additional lights directed toward the motorist, the motorist is more easily able to see the lights. This is particularly helpful in poor weather conditions, as well as in sunny conditions in which the glare from the sun can cause visibility concerns.

As previously discussed, the lights 26′, 28′, 30′ on the rear sides 14 of the traffic signals 10 may have a different configuration or shape from the lights on the front side 12. One such configuration is shown in FIG. 5. The use of a different shape can enhance the safety features of the traffic signals 10. As a motorist approaches an intersection, he/she recognizes that his/her lanes of traffic are indicated by the conventional round shape of the light. Consequently, if a motorist views a traffic signal 10 with a different shape, he/she recognizes that the lanes of traffic under the traffic signals 10 with the different shape are for oncoming traffic. Therefore, the motorist will know not to enter those lanes with his/her vehicle. This can be particularly advantageous in conditions of poor weather visibility, i.e. fog.

Referring again to FIG. 3, all of the traffic signals 10 shown are of the type described. However, the control system 2 does not require that all traffic signals be of the type of traffic signals described herein. Some of the traffic signals used may be conventional known signals, while others may be traffic signals 10. The determination as to which traffic signals will be traffic signals 10 and which will be conventional signals is based on various factors, including the configuration of the intersections and the safety factors relevant thereto.

While the use of lights on both the front face 12 and rear face 14 have been discussed, it is within the scope of this invention to use lights on the side surfaces 16 in a manner similar to that described herein. In certain intersections, the use of light on side surfaces 16 may provide the same benefits described.

As mentioned in the background information, traffic control signals of the type described are widely used, and in general have been quite satisfactory. However, the use of the traffic control system 2 and traffic signals 10, as described herein, has several advantages. The advantages include that traffic control system 2 and traffic signals 10 provide additional warning to the motorist by providing additional functionality to the traffic signals 10, allowing the motorist to view the appropriate signal without obstruction. The traffic control system 2 and traffic signals 10 provide additional safety benefits without significantly increasing the cost to municipalities and other entities which purchase traffic signals associated with the installation of additional, stand-alone traffic signals.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A traffic signal for controlling traffic in a first lane of traffic and a second lane of traffic which is opposed to the first lane of traffic, the traffic signal comprising:
a first face having a first red light, a first amber light and a first green light, the first face directed to and controlling traffic travelling in a first direction in the first lane of traffic;
a second face having a second red light, a second amber light and a second green light, the second face directed to and controlling traffic in a second direction in the second lane of traffic, the second direction being opposed to the first direction;
the traffic signal being positioned proximate the first lane of traffic;
whereby traffic travelling in the second lane of traffic has an unobstructed view of the second face of the traffic signal.

2. The traffic signal as recited in claim 1, wherein the first red light, the first amber light and the first green light have different shapes than the second red light, the second amber light and the second green light.

3. The traffic signal as recited in claim 1, wherein the switching between the first red light, the first amber light and the first green light on the first face is sequenced with the switching between the second red light, the second amber light and the second green light on the second face.

4. The traffic signal as recited in claim 1, wherein the traffic signal is positioned over the first lane of traffic and is mounted overhead.

5. The traffic signal as recited in claim 1, wherein the traffic signal is positioned next to the first lane of traffic and is mounted on a pole which extends from the shoulder of the first lane of traffic.

6. The traffic signal as recited in claim 1, wherein the traffic signal is provided proximate a stop line of the intersection for the second lane of traffic.

7. The traffic signal as recited in claim 1, wherein the traffic signal is provided proximate a stop line of the intersection for the first lane of traffic.

8. A traffic control system comprising:
one or more first traffic signals which are positioned over a first lane of traffic in which vehicles move in a first direction;
one or more second traffic signals which are positioned over a second lane of traffic in which vehicles move in a second direction;
at least one of the first traffic signals comprising:
a first face having a first red light, a first amber light and a first green light, the first face directed to and controlling vehicles travelling in the first direction in the first lane of traffic;
a second face having a second red light, a second amber light and a second green light, the second face directed to and controlling vehicles in the second direction in the second lane of traffic, the second direction being opposed to the first direction;
the at least one first traffic signal being positioned proximate the first lane of traffic;
whereby vehicles travelling in the second lane of traffic have an unobstructed view of the second face of the at least one first traffic signal.

9. The traffic control system as recited in claim 8, wherein the first red light, the first amber light and the first green light of the at least one of the traffic signals have different shapes than the second red light, the second amber light and the second green light of the at least one of the traffic signals.

10. The traffic control system as recited in claim 8, wherein the switching between the first red light, the first amber light and the first green light on the first face of the at least one of the traffic signals is sequenced with the switching between the second red light, the second amber light and the second green light on the second face of the at least one of the traffic signals.

11. The traffic control system as recited in claim 8, wherein the at least one of the traffic signals is positioned over the first lane of traffic and is mounted overhead.

12. The traffic control system as recited in claim 8, wherein the at least one of the traffic signals is positioned next to the first lane of traffic and is mounted on a pole which extends from the shoulder of the first lane of traffic.

13. The traffic control system as recited in claim 8, wherein the at least one of the traffic signals is provided proximate a stop line of the intersection for the second lane of traffic.

14. The traffic control system as recited in claim 8, wherein the at least one of the traffic signals is provided proximate a stop line of the intersection for the first lane of traffic.

15. The traffic control system as recited in claim 8, wherein multiple of the at least one of the traffic signals are provided in the control system.

16. A traffic control system to increase traffic signal visibility, the traffic control system comprising:
a traffic signal having a first face and an oppositely facing second face;
the first face having a first red light, a first amber light and a first green light, the first face directed to and controlling vehicles travelling in a first direction in a first lane of traffic;
the second face having a second red light, a second amber light and a second green light, the second face directed to and controlling vehicles in a second direction in a second lane of traffic, the second direction being opposed to the first direction;
the traffic signal being positioned over the first lane of traffic;
whereby vehicles travelling in the second lane of traffic have an unobstructed view of the second face of the at least one first traffic signal.

17. The traffic control system as recited in claim 16, wherein the switching between the first red light, the first amber light and the first green light on the first face of the traffic signal is sequenced with the switching between the second red light, the second amber light and the second green light on the second face of the traffic signal.

18. The traffic control system as recited in claim 17, wherein the first red light, the first amber light and the first green light of the traffic signal have different shapes than the second red light, the second amber light and the second green light of the traffic signal.

19. The traffic control system as recited in claim 18, wherein the traffic signal is provided proximate a stop line of the intersection for the second lane of traffic.

20. The traffic control system as recited in claim 18, wherein more than one traffic signal is provided in the control system.
